(19) United States
(12) Patent Application Publication
(10) Pub. No.: US 2025/0307824 A1
(43) Pub. Date: Oct. 2, 2025

(54) GENERATING AND UTILIZING MOVEMENT IDENTIFIERS TO IDENTIFY NETWORK TRANSACTIONS IN NETWORK TRANSACTIONS INITIATED AS SECURED DEPOSIT NETWORK TRANSACTION CHAINS

(71) Applicant: Chime Financial, Inc., San Francisco, CA (US)

(72) Inventors: Taylor Lentz, South Lake Tahoe, CA (US); David Lyons, Oakland, CA (US)

(21) Appl. No.: 18/619,679

(22) Filed: Mar. 28, 2024

(51) Int. Cl. G06Q 20/40; G06Q 20/26

(52) U.S. Cl. CPC G06Q 20/4016; G06Q 20/26

(57) ABSTRACT

The present disclosure relates to systems, non-transitory computer-readable media, and methods for generating and utilizing movement identifiers to identify transactions in a secured deposit network transaction chain. In particular, in one or more embodiments, the disclosed systems initiate a network transaction as a secured deposit network transaction chain comprising a first intermediate transaction from a secured deposit account to a debit account and a second intermediate transaction from the debit account to an additional account. Moreover, the disclosed systems intelligently display the network transaction in a user interface by displaying the network transaction as a transaction from the secured deposit account to the additional account.

### BACKGROUND

In recent years, the proliferation of web and mobile applications to track and identify network transactions has increased. For example, client devices can view and manage transactions, account balances, and other information over computer networks using an application on the client device. For instance, conventional transaction management systems can display, and facilitate the management of account balances and transaction history for accounts associated with specific financial institutions. In addition, many conventional transaction management systems include features that allow a client device to initiate network transactions, such as by sending or transferring tokens, currency, or data to another account, institution, or client device. Indeed, the proliferation of network capabilities and speeds allows client devices to initiate network transactions in near real-time. Despite these recent advances, however, conventional transaction management systems continue to exhibit a number of technical drawbacks and deficiencies.

For example, conventional transaction management systems are inflexible. Indeed, most conventional transaction management systems facilitate only atomic debit or credit transactions, comprising a transfer from one account to another, where the balance of each account reflects a balance increase or decrease for the amount of the transfer. Moreover, conventional transaction management systems offer only limited options to transfer digital assets to additional accounts. For example, conventional transaction management systems allow a customer to only send assets using debit accounts fully funded in the amount of the transaction.

In part due to their inflexibility, conventional transaction management systems are also inaccurate. Because they only facilitate atomic transactions, conventional transaction management systems fail to identify transactions associated with each other within the transaction. For example, conventional transaction management systems often require human intervention using accounting or other systems in order to identify and link transactions together. Indeed, when client devices are required to submit multiple transactions in order to transfer money from a certain account, these related network transactions are not identified as part of a single transaction and may be mislabeled or, more often, simply not labeled as related transactions at all.

In addition, conventional transaction management systems are inefficient with their computer resources. Indeed, by facilitating only atomic transactions, conventional transaction management systems often expend excessive computational resources such as computing time and processing power in generating, transmitting, and processing information related to each individual transaction. To illustrate, when a client device initiates multiple network transactions in order to access funds in certain accounts, conventional transaction management systems must generate and utilize multiple user interfaces in order to present and receive information from the client device, along with the additional computing time and processing resources to do so. These, along with additional problems and issues, exist with regard to conventional transaction management systems.

### BRIEF SUMMARY

Embodiments of the present disclosure provide benefits and/or solve one or more of the foregoing or other problems in the art with systems, non-transitory computer-readable media, and methods for generating and utilizing movement identifiers to identify transactions in a network transaction initiated as a secured deposit network transaction chain. For example, upon receiving a request to initiate a network transaction between a secured deposit account and an additional account, the disclosed systems generate a movement identifier for the network transaction and initiate the network transaction as a secured deposit network transaction chain that includes a sequence of intermediate transactions that transfer money through an intermediate account in order to facilitate network transactions between a secured debit account and an additional account. In one or more embodiments, the disclosed systems intelligently identify intermediate transactions and elect not to display the intermediate transactions and display the network transaction on a client device as a transaction from the secured deposit account to the additional account. Additional features and advantages of one or more embodiments of the present disclosure are outlined in the description which follows and, in part, will be obvious from the description or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a network transaction tracking system can operate in accordance with one or more embodiments.

FIG. 2 illustrates an example diagram of an overview of a network transaction tracking system initiating network transactions as a secured deposit network transaction chain in accordance with one or more embodiments.

FIG. 3 illustrates a schematic diagram of a network transaction tracking system generating movement identifiers and utilizing the movement identifiers to identify network transactions in a secured deposit network transaction chain in accordance with one or more embodiments.

FIG. 4 illustrates a schematic diagram of generating a risk profile for a secured network transaction chain in accordance with one or more embodiments.

FIGS. 5A-5C illustrate example user interfaces of the network transaction tracking system and a schematic diagram of the network transaction determining information to display in the user interface device in accordance with one or more embodiments.

FIG. 6 illustrates an example series of acts for using a database migration system in accordance with one or more embodiments.

FIG. 7 illustrates a block diagram of an example computing device for implementing one or more embodiments of the present disclosure.

FIG. 8 illustrates an example environment for an inter-network facilitation system in accordance with one or more embodiments.

### DETAILED DESCRIPTION

This disclosure describes one or more embodiments of a network transaction tracking system that initiates network transactions as a secured deposit network transaction chain and generates a movement transaction to identify transactions in the secured deposit network transaction chain. Specifically, the network transaction tracking system receives a request to initiate a network transaction and initiates the network transaction as the secured deposit network transaction chain, utilizing multiple network transactions to move currency or data from a source account (e.g., a secured deposit account), through an intermediate account (e.g., a debit account linked to the secured deposit account), and to the destination account. The network transaction tracking system can use the movement identifier to identify the individual transactions in the secured deposit network transaction chain to stitch together the transactions in the secured network transaction chain in order to identify transactions. Indeed, by using the movement identifier to stitch together transactions through multiple accounts, the network transaction tracking system allows a client device to initiate transactions that may not be directly supported (e.g., appearing to use a credit card for the appearance of direct payments, which is normally not supported by credit cards) while also satisfying reporting requirements.

As just mentioned, the network transaction tracking system initiates a network transaction as a secured deposit network transaction chain. In one or more embodiments, the network transaction tracking system initiates the secured deposit network transaction chain by initiating a first intermediate transaction from the source account (e.g., a secured deposit account) and an intermediate account (e.g., a debit account) and then initiating a second intermediate transaction from the intermediate account to the additional account. Further, the network transaction tracking system associates the movement identifier with each transaction in the secured deposit network transaction chain in order to identify which individual transactions constitute the network transaction. In some cases, the network transaction tracking system also generates an intermediate movement identifier for each intermediate transaction that refers to the movement identifier. The network transaction tracking system can then report the movement identifier and any intermediate movement identifiers to a reporting server in order to identify the network transaction and satisfy reporting requirements.

In one or more embodiments, the network transaction tracking system generates a risk prediction for the network transaction that indicates a prediction about the risk failure of the network transaction. Specifically, the network transaction tracking system generates a risk prediction by generating a risk score for each transaction in the secured deposit network transaction chain in order to generate a risk prediction. In some cases, the network transaction tracking system reorders the transactions in the secured deposit network transaction chain, generating a risk score for the second intermediate transaction and then generating a risk score for the first intermediate transaction.

In addition, in one or more embodiments, the network transaction tracking system displays limited information about the network transaction to streamline corresponding user interfaces. Specifically, the network transaction tracking system displays, within a user interface on a client device, the network transaction by displaying a transaction from the source account to the destination account. For example, the network transaction tracking system identifies that the intermediate transactions are part of a secured deposit transaction chain for the network transaction and does not display the first intermediate transaction and the second intermediate transaction in the user interface on the client device.

In one or more embodiments, the network transaction tracking system reverses the network transaction by initiating an additional secured deposit network transaction chain. For example, upon receiving a request to reverse the network transaction, the network transaction tracking system utilizes the movement identifier to identify the intermediate transactions and generate an additional movement identifier for an additional network transaction. The network transaction tracking system then initiates the network transaction as an additional secured deposit network transaction chain utilizing the additional movement identifier by initiating a third intermediate transaction from the destination account to the intermediate account (e.g., debit account) and a fourth intermediate transaction from the intermediate account to the source account (e.g., secured deposit account).

The network transaction tracking system provides a variety of technical advantages relative to conventional systems. For example, by generating a movement identifier (or multiple movement identifiers) to identify various transactions in a secured deposit network transaction chain, the network transaction tracking system improves flexibility relative to conventional systems. Specifically, because the network transaction tracking system can utilize movement identifiers to stitch together transactions between various types of secured deposit accounts, the network transaction tracking system facilitates transactions between accounts that other systems generally cannot facilitate. For example, the network transaction tracking system can provide options for a client device to initiate a network transaction from a credit account to an additional account (e.g., a peer-to-peer transaction) by utilizing intermediate transactions that ensure there are sufficient funds to satisfy the transaction. Indeed, because the network transaction tracking system can identify all transactions belonging to a secured deposit transaction chain, along with where each individual transaction belongs in the secured deposit transaction chain (e.g., intermediate transactions), the network transaction tracking system can provide additional options for network transactions while also satisfying regulatory reporting requirements.

In addition, the network transaction tracking system improves accuracy over conventional transaction management systems. Specifically, by utilizing the movement identifier to stitch together secured deposit network transaction chains, the network transaction tracking system can identify related transactions that conventional transaction management systems fail to associate together (or that require human intervention to associate together), such as with accounting systems or by labeling the transactions. For example, the network transaction tracking utilizes a movement identifier to identify the secured deposit network transaction chain, plus movement identifiers for each individual transaction (e.g., each intermediate transaction) that refer to the movement identifier for the secured deposit network transaction chain, accurately and intelligently identifying related transactions.

Moreover, the network transaction tracking system improves efficiency relative to conventional transaction management systems. Specifically, the network transaction tracking system intelligently displays information that relates to the network transaction to a client device. For example, as the network transaction tracking system utilizes intermediate transactions to facilitate network transactions, the network transaction tracking system can elect to display transaction the secured deposit network transaction chain by displaying a transaction between an account (e.g., a secured deposit account) and an additional account, while electing to not display the intermediate transfers to other accounts. Moreover, by offering options to initiate transactions between accounts that would otherwise require initiating multiple transactions, the network transaction tracking system also saves computing time and processing power by not generating multiple interfaces to initiate, confirm, and display information relative to each individual transaction.

As illustrated by the foregoing discussion, the present disclosure utilizes a variety of terms to describe the features and advantages of the network transaction tracking system. Additional detail is now provided regarding the meaning of such terms. For example, as used herein, the term “network transaction” refers to a transaction performed as part of an exchange of tokens, currency, or data between accounts or other connections of the system. In some embodiments, the network transaction may be a request to transfer tokens, currency, or data into an account associated with the network transaction. In other embodiments, the network transaction may be a deposit of tokens, currency, or data into an account (e.g., as a paycheck).

In addition, as used herein, the term “secured credit card account” refers to a financial account associated with a user that comprises a secured credit card. Specifically, “secured credit card account” refers to a user account where the credit limit of the account is a predetermined balance that can be automatically transferred from an account that stores currency (e.g., checking account or savings account) to the secured credit card account. As used herein, the term “secured deposit account” refers to a checking or savings account that stores currency and is associated with a secured credit card account. Specifically, the predetermined balance of the secured credit card account reflects the required amount in the secured deposit account. In some embodiments, once the secured credit card account hits the predetermined balance, the user cannot make further transactions on the secured credit card account (e.g., cannot use the secured credit card). In some embodiments, once the secured credit card account hits the predetermined balance, the inter-network facilitation system can automatically pay off a balance of the secured credit account with the predetermined balance money held in the secured credit account.

In addition, as used herein, the term “secured deposit network transaction chain” refers to a set or series of transactions that make up a network transaction. Specifically, the term “secured deposit network transaction chain” refers to a network transaction that utilizes multiple transactions to transfer tokens, currency, or data from one account to another. In some embodiments, a secured deposit network transaction chain refers to transactions that are completed in sequence, where tokens, currency, or data move through multiple accounts in order to complete a transaction.

Further, as used herein, the term “intermediate transaction” refers to a transaction that is part of a secured deposit network transaction chain but is not the destination account for the network transaction. Specifically, the term “intermediate transaction” refers to a transaction in which tokens, currency, or data pass through an account on the way to a designated or destination account. For example, an intermediate transaction can include a transfer of tokens, currency, or data from a selected account to an intermediate account, such as a debit account, or from an intermediate account to a destination account. In some embodiments, a secured deposit network transaction chain will include multiple intermediate transactions, such as a first intermediate transaction crediting (or adding to) an amount from an initial account to an intermediate account and a second intermediate transaction debiting (or taking away) the amount from the intermediate account to the destination account.

Further, as used herein, the term “debit account” refers to a type of account that holds currency and from which currency can be added or withdrawn. Specifically, the term “debit account” refers to an account where a network transaction withdrawing currency results in a deduction of funds from the account balance. In some embodiments, a debit account only allows network transactions to remove money (e.g., spending, transfers, or other withdrawals) within the available balance of the account.

Moreover, as used herein, the term “movement identifier” refers to a unique label used to distinguish and reference a network transaction. Specifically, the term “movement identifier” is a label or other reference system that is associated or attached to a network transaction and/or each transaction in a secured deposit network transaction chain that identifies the source and destination for tokens, currency, or data exchanged in the network transaction. In addition, as used herein, the term “intermediate movement identifier” refers to a unique label used to distinguish and reference an intermediate transaction that makes up part of the secured deposit network transaction chain. In one or more embodiments, an intermediate movement identifier refers to the movement identifier. For example, the intermediate movement identifier can refer to the movement identifier in order to clearly identify the source and destination of funds in the network transaction, not just the intermediate transaction.

Also, as used herein, the term “risk prediction” refers to a classification or metric indicating a risk associated with a network transaction or secured deposit network transaction chain. In some embodiments, a “risk prediction” comprises a value indicating a likelihood that a network transaction or secured deposit network transaction chain will fail, such as due to a lack of funds in the intermediate account or because the network transaction is fraudulent, unauthorized, outside of the account holder's control, or otherwise lacks legitimacy. For example, a “risk prediction” can comprise a score (e.g., a number, a fraction, or other numerical indicators) indicating a degree to which an algorithm, machine-learning model, third-party risk analysis server predicts a network transaction, or secured deposit transaction chain, will fail or the network transaction is unauthorized or otherwise fraudulent. As another example, the risk score could be a classifier, such as a “0,” a “1,” or a “yes” or “no,” indicating that the network transaction is or is not unauthorized or fraudulent. In one or more embodiments, a risk prediction refers to an overall risk prediction for a network transaction, including all the transactions in the secured deposit network transaction chain, and a “risk score” indicates the likelihood that a transaction in the secured deposit network transaction chain will fail. For example, a “risk score” can be a value or score indicating a likelihood that a network transaction in the secured deposit network transaction chain (e.g., one of the intermediate transactions) will fail, such as due to a lack of funds in one or more of the accounts or because the network transaction is fraudulent, unauthorized, outside of the account holder's control, or otherwise lacks legitimacy.

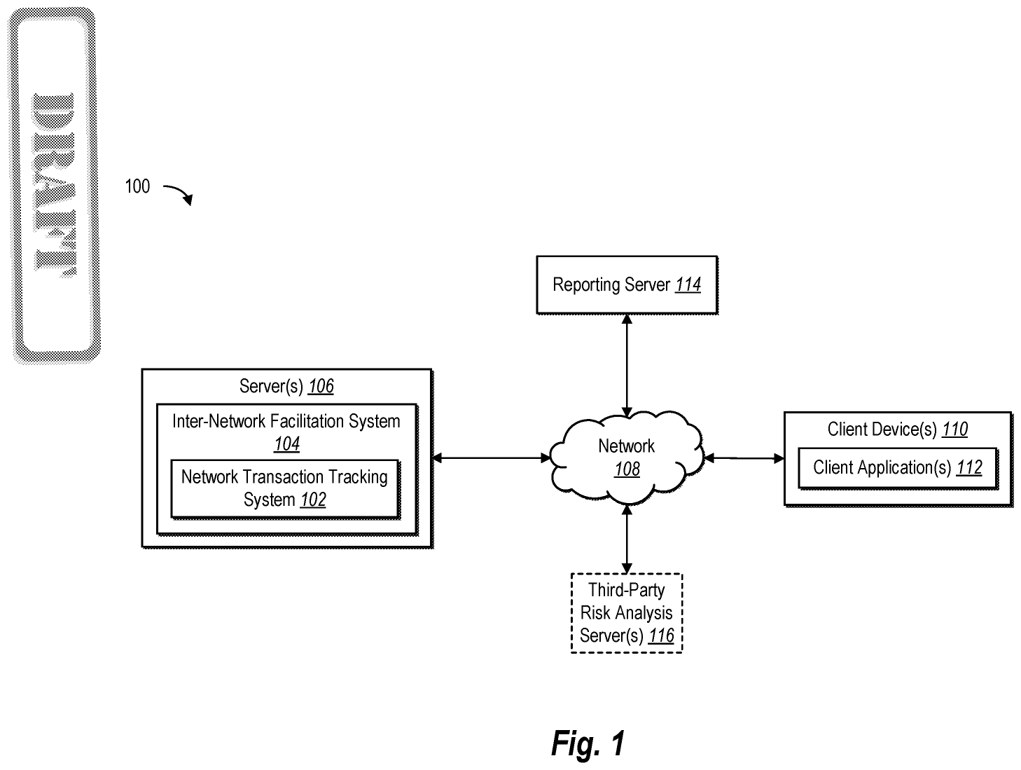

Turning now to the figures, FIG. 1 illustrates a block diagram of a system 100 (or system environment) for implementing an inter-network facilitation system 104 and a network transaction tracking system 102 in accordance with one or more embodiments. As shown in FIG. 1, system 100 includes server(s) 106 (which includes inter-network facilitation system 104 and network transaction tracking system 102), client device(s) 110, reporting server 114, and third-party risk analysis server(s) 116. As further illustrated in FIG. 1, the server(s) 106, the client device(s) 110, the reporting server 114, and the third-party risk analysis server(s) 116 can communicate via the network 108.

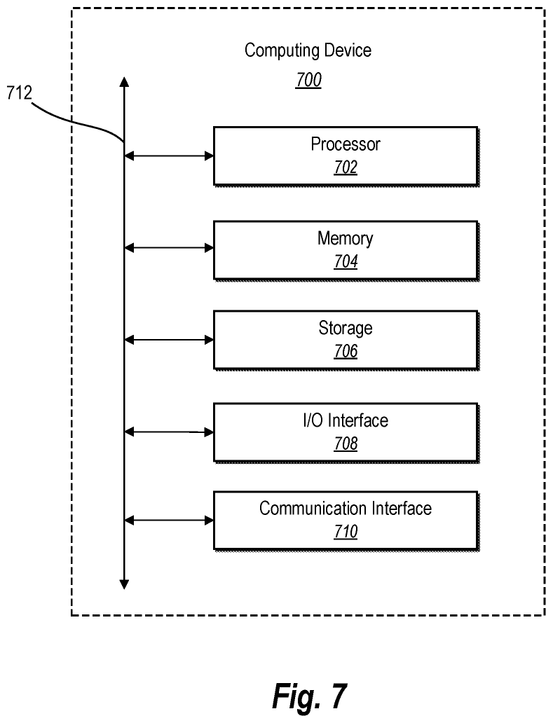

Although FIG. 1 illustrates the network transaction tracking system 102 being implemented by a particular component and/or device within system 100, the network transaction tracking system 102 can be implemented, in whole or in part, by other computing devices and/or components within the system 100 (e.g., the client device(s) 110). Additional description regarding the illustrated computing devices (e.g., the server(s) 106, computing devices implementing the network transaction tracking system 102, the client device(s) 110, and/or the network 108) is provided with respect to FIGS. 7 & 8 below.

As shown in FIG. 1, the server(s) 1-6 can include the inter-network facilitation system 104. In some embodiments, the inter-network facilitation system 104 can determine, store, generate, and/or display financial information corresponding to a user account (e.g., in a banking application or a money transfer application). Furthermore, the inter-network facilitation system 104 can also electronically communicate (or facilitate) financial transactions between one or more user accounts (and/or computing devices). Moreover, the inter-network facilitation system 104 can also track and/or monitor financial transactions and/or financial transaction behaviors of a user within a user account.

The inter-network facilitation system 104 can include a system that comprises the network transaction tracking system 102 and that facilitates financial transactions and digital communications across different computing systems over one or more networks. For example, the inter-network facilitation system 104 manages credit accounts, secured accounts, and other accounts for one or more accounts registered within the inter-network facilitation system 104. In some cases, the inter-network facilitation system 104 is a centralized network system that facilitates access to online banking accounts, credit accounts, and other accounts within a central network location. Indeed, the inter-network facilitation system 104 can link accounts from different network-based financial institutions to provide information regarding, and management tools for, the different accounts.

Furthermore, as shown in FIG. 1, system 100 also includes the reporting server 114. In one or more embodiments, the reporting server receives or accesses a movement identifier and/or one or more intermediate movement identifiers in order to satisfy various regulatory requirements regarding network transactions. For instance, the network transaction tracking system 102 can send a movement identifier for a network transaction (e.g., an overall identifier), along with one or more intermediate movement identifiers identifying intermediate transactions that are a part of the network transaction as a secured deposit network transaction chain. In one or more embodiments, the network transaction tracking system 102 generates a movement identifier that references movement identifiers for one or more intermediate transactions and/or movement identifiers for one or more intermediate transactions that reference the movement identifier for the network transaction.

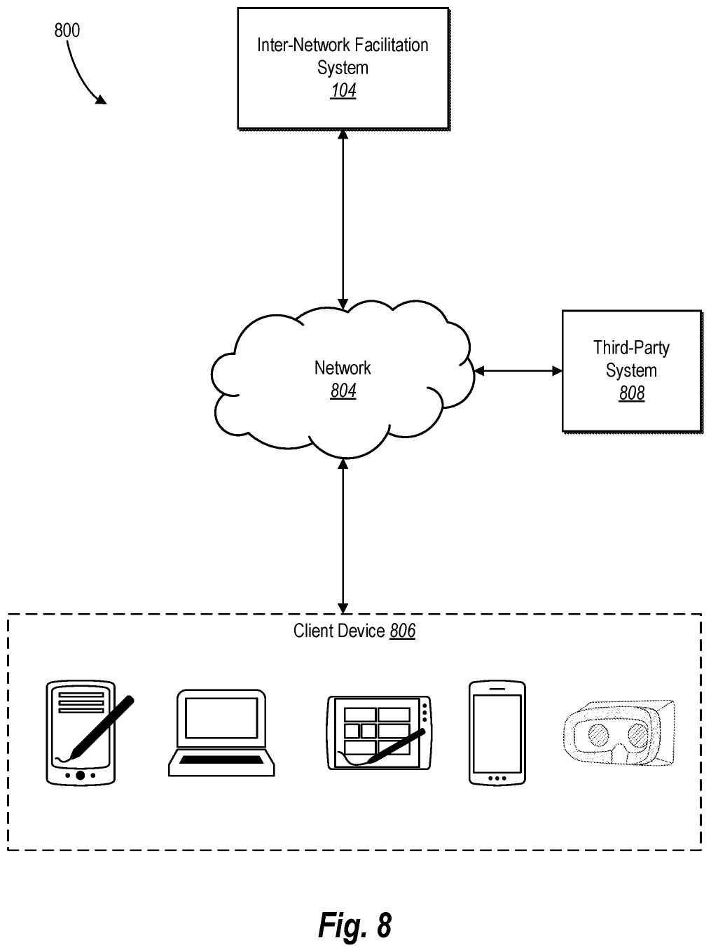

As also illustrated in FIG. 1, system 100 includes the client device(s) 110. For example, the client device(s) 110 may include, but are not limited to, mobile devices (e.g., smartphones, tablets) or other types of computing devices, including those explained below with reference to FIGS. 7 and 8. Additionally, the client device(s) 110 can include computing devices associated with (and/or operated by) user accounts for the inter-network facilitation system 104. Moreover, system 100 can include various numbers of client devices that communicate and/or interact with the inter-network facilitation system 104 and/or the network transaction tracking system 102.

Furthermore, as shown in FIG. 1, the client device(s) 110 can include client application(s) 112. Client application(s) 112 can include instructions that (upon execution) cause the client device(s) 110 to perform various actions. For example, a user of a user account can interact with client application(s) 112 on client device(s) 110 to access financial information, initiate a financial transaction (e.g., transfer money to another account, deposit money, withdraw money), and/or access or provide data (to the server(s) 106). Furthermore, in one or more implementations, the client application(s) 112 can display one or more graphical user interfaces from which the network transaction tracking system 102 can receive and display information regarding network transactions.

In certain instances, the client device(s) 110 corresponds to one or more user accounts (e.g., user accounts stored at the server(s) 106). For instance, a user of a client device can establish a user account with login credentials and various information corresponding to the user. In addition, the user accounts can include a variety of information regarding financial information and/or financial transaction information for users (e.g., name, telephone number, address, bank account number, credit amount, debt amount, financial asset amount), payment information (e.g., account numbers), transaction history information, and/or contacts for financial transactions. In some embodiments, a user account can be accessed via multiple devices (e.g., multiple client devices) when authorized and authenticated to access the user account within the multiple devices.

The present disclosure utilizes client devices to refer to devices associated with such user accounts. In referring to a client (or user) device, the disclosure and the claims are not limited to communications with a specific device but any device corresponding to a user account of a particular user. Accordingly, in using the term client device, this disclosure can refer to any computing device corresponding to a user account of the inter-network facilitation system 104.

As illustrated in FIG. 1, system 100 includes third-party risk analysis server(s) 116. In one or more embodiments, the third-party risk analysis server(s) receives or accesses network transaction information and/or additional data associated with a network transaction (e.g., user data, historical transaction data, location data, etc.) from the inter-network facilitation system 104 and/or the network transaction tracking system 102 to generate a risk prediction for the network transaction. In some cases, the third-party risk analysis server(s) receives information and/or data associated with each transaction that makes up the secured deposit network transaction chain of the network transaction (e.g., intermediate transactions) from the network transaction tracking system 102 and/or the inter-network facilitation system 104 in order to generate a risk prediction for the network transaction. As illustrated, third-party risk analysis server(s) 116 can be located on a separate server. In some cases, the third-party risk analysis server can be integrated or included in the network transaction tracking system 102 or the inter-network facilitation system 104.

As further shown in FIG. 1, the system 100 includes the network 108. As mentioned above, the network 108 can enable communication between components of the system 100. In one or more embodiments, the network 108 may include a suitable network and may communicate using a various number of communication platforms and technologies suitable for transmitting data and/or communication signals, examples of which are described with reference to FIG. 8. Furthermore, although FIG. 1 illustrates the server(s) 106, the client device(s) 110, the reporting server 114, and the third-party risk analysis server(s) 116 communicating via the network 108, the various components of the system 100 can communicate and/or interact via other methods (e.g., the server(s) 106 and the client device(s) 110 can communicate directly).

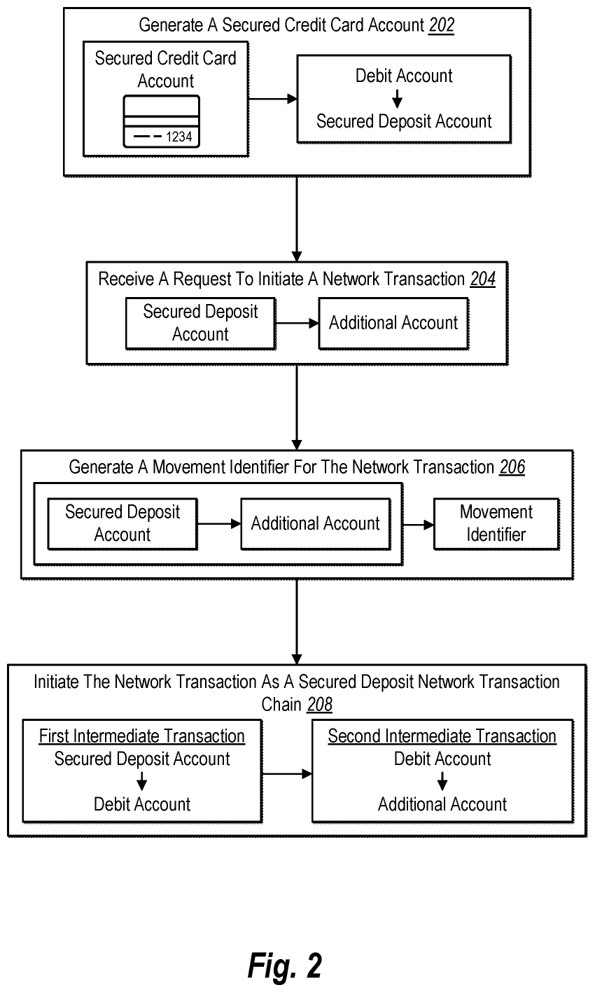

As previously mentioned, the network transaction tracking system 102 generates and utilizes a movement identifier for a network transaction initiated as a secured deposit network transaction chain. Specifically, the network transaction tracking system 102 utilizes the movement identifier to identify (or stitch together) a sequence of transactions in a secured deposit network transaction chain, where the funds go from a source account, through an intermediate account, to a destination account. FIG. 2 illustrates an example diagram of an overview of the network transaction tracking system 102 initiating network transactions as a secured deposit network transaction chain in accordance with one or more embodiments. Additional detail regarding the various acts illustrated in FIG. 2 is provided thereafter with reference to the subsequent figures.

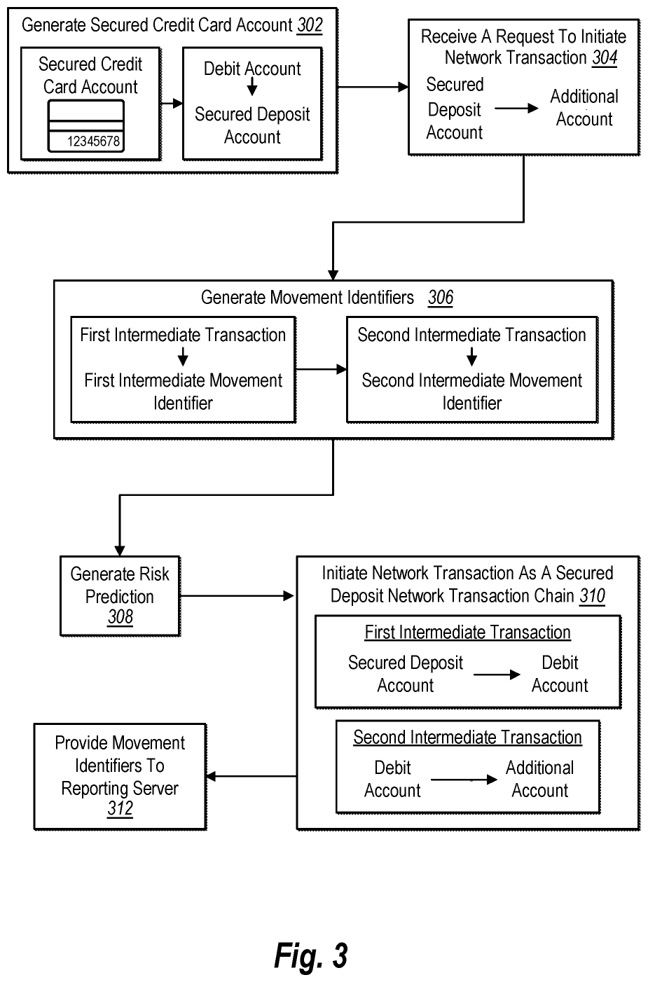

As illustrated in FIG. 2, the network transaction tracking system 102 performs an act 202 and generates a secured credit card account. In particular, the network transaction tracking system 102 generates a secured credit card account corresponding to a secured deposit account. For example, the secured credit card account has a predetermined balance based on a balance in the secured deposit account. The secured deposit account is associated with a debit account, which is used to fund the secured deposit account (e.g., by initiating network transactions from the debit account to the secured deposit account). Additional detail regarding funding the secured credit card account using the secured deposit account and/or the debit account is discussed further with respect to FIG. 3 below.

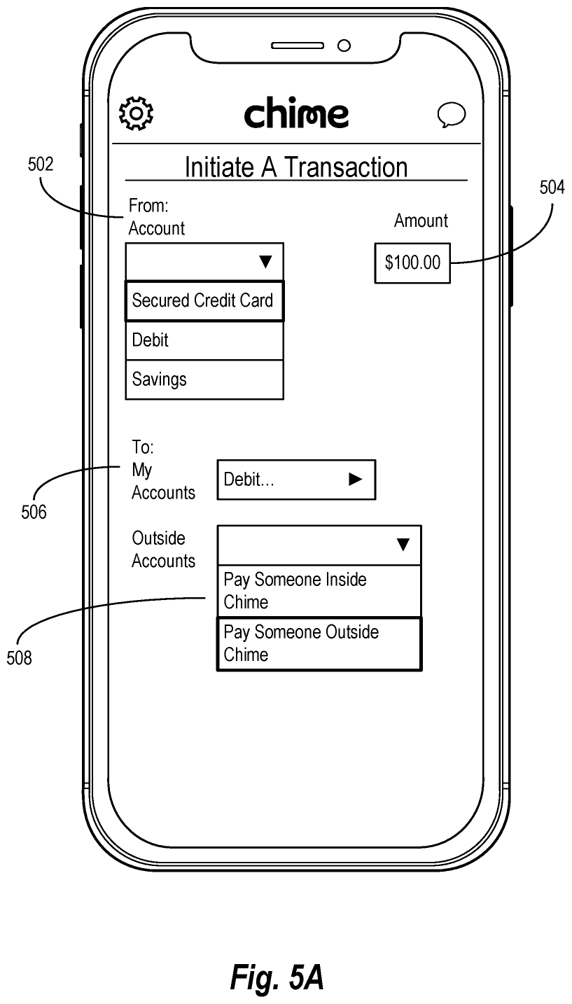

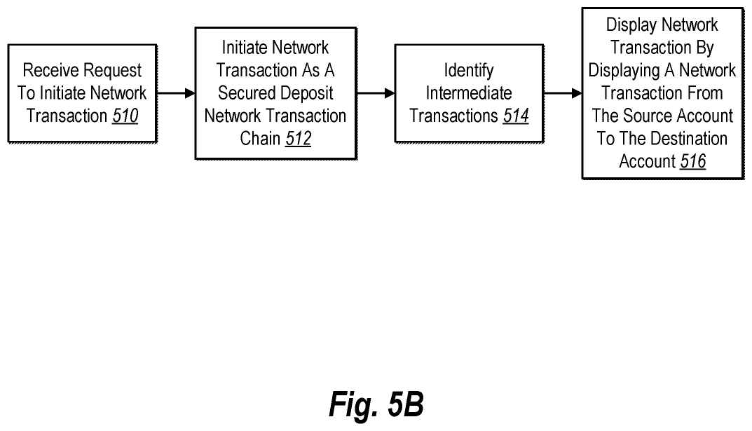

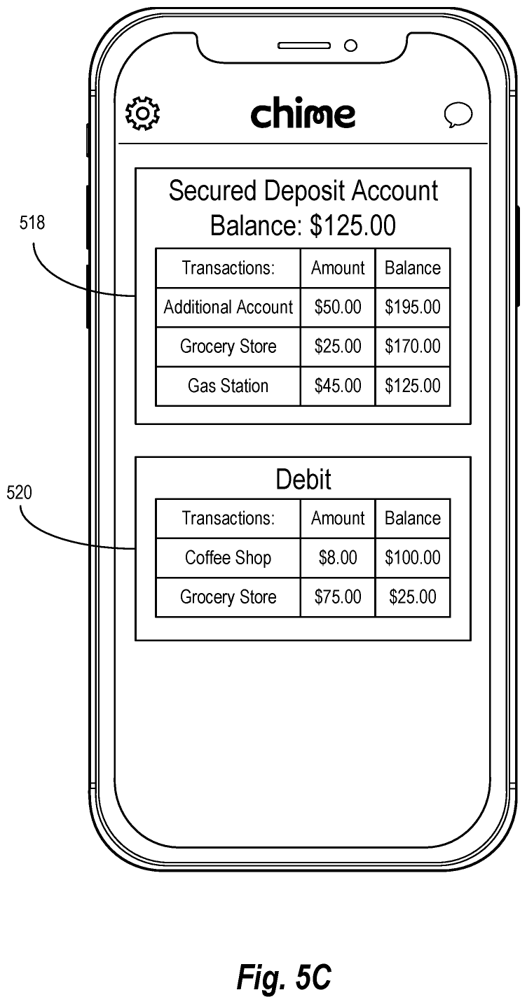

As also illustrated in FIG. 2, the network transaction tracking system 102 performs an act 204 and receives a request to initiate a network transaction. Specifically, the network transaction tracking system 102 receives a request to initiate a network transaction from a secured deposit account to an additional account. For example, the network transaction tracking system 102 receives a request from a client device associated with the secured deposit account to initiate the network transaction. Additional details regarding the network transaction tracking system 102 receiving a request to initiate a network transaction will be provided with respect to FIGS. 3 and 5A below.

Further, as illustrated in FIG. 2, the network transaction tracking system 102 performs an act 206 and generates a movement identifier for the network transaction. In particular, the network transaction tracking system 102 generates a movement identifier as a unique identifier that identifies the source account and a destination account for the network transaction. For example, the movement identifier can indicate that the source account for the network transaction is the secured deposit account and the destination account for the network transaction is the additional account. In some cases, the network transaction tracking system 102 generates intermediate movement identifiers that identify the source account and destination account for the intermediate transactions. Additional detail regarding the network transaction tracking system 102 generating movement identifiers for the network transaction and the intermediate network transactions will be provided with respect to FIG. 3 below.

As illustrated in FIG. 2, the network transaction tracking system 102 performs an act 208 and initiates the network transaction as a secured deposit network transaction chain. Specifically, the network transaction tracking system 102 can initiate a secured deposit network transaction chain by utilizing intermediate transactions that pass money through an intermediate account. For example, the network transaction tracking system 102 can initiate the secured deposit network transaction chain by initiating a first intermediate transaction from a secured deposit account (the source account) to a debit account and then initiating a second intermediate transaction from the debit account to the additional account (the destination account).

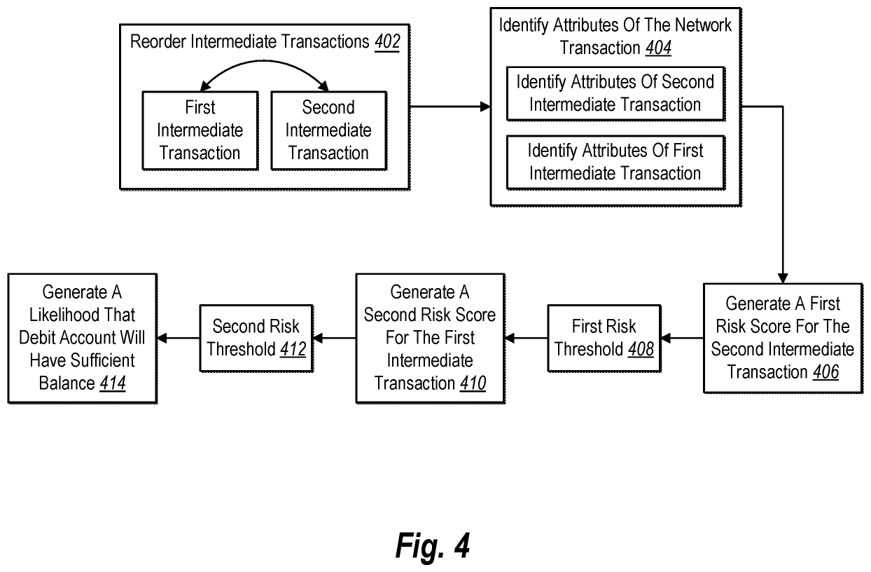

In one or more embodiments, prior to initiating the network transaction as a secured deposit network transaction chain, the network transaction tracking system 102 generates a risk prediction for the network transaction that indicates a risk of failure of the network transaction (e.g., due to insufficient funds in one of the accounts or fraudulent activity in one or more of the accounts). In particular, the network transaction tracking system 102 generates a risk prediction for the network transaction based on risk scores for each of the transactions in the secured deposit network transaction chain. For example, the network transaction tracking system 102 reorders the transactions in the secured deposit network transaction chain and generates a first risk score for the second intermediate transaction (from the intermediate account to the destination account) and then, if the first risk score satisfies a risk threshold, generating a second risk score for the first intermediate transaction (from the source account to the intermediate account). In some cases, the network transaction tracking system 102 can also consider attributes of the network transaction (e.g., as a whole) when generating a risk prediction for the network transaction. Additional details regarding generating a risk prediction for the network transaction will be discussed further with respect to FIG. 4 below.

In addition, in one or more embodiments, the network transaction tracking system 102 identifies and displays limited information about the network transaction. In particular, the network transaction tracking system 102 identifies that the network transaction comprises a secured deposit network transaction chain and displays the network transaction by displaying a network transaction from the source account to the destination account. For example, the network transaction tracking system 102 can identify that the first intermediate transaction and the second intermediate transaction are intermediate transactions and determine to display the network transaction within a user interface on the client device by displaying a network transaction from the secured deposit account to the additional account. Additional details regarding displaying network transactions comprising secured deposit network transaction chains by displaying the source account and the destination account are provided further with respect to FIGS. 5A-5C below.

As previously mentioned, the network transaction tracking system 102 generates movement identifiers for network transaction and intermediate movement identifiers for intermediate transactions in a secured deposit network transaction chain of the network transaction. Specifically, the network transaction tracking system 102 generates and utilizes movement identifiers and intermediate movement identifiers to identify and stitch together the sequence of transactions in a secured deposit network transaction chain of a network transaction. FIG. 3 illustrates a schematic diagram of a network transaction tracking system generating movement identifiers and utilizing the movement identifiers to identify network transactions in a secured deposit network transaction chain in accordance with one or more embodiments.

As illustrated in FIG. 3, the network transaction tracking system 102 performs an act 302 and generates a secured credit card account. In particular, the network transaction tracking system 102 generates a secured credit card account corresponding to a secured deposit account and where the secured deposit account is linked to a debit account. The network transaction tracking system 102 generates the secured credit card account utilizing a predetermined balance that is based on a balance of the secured deposit account. For example, the spending power of the secured credit card is equal to the balance of the secured deposit account. In some embodiments, once the secured credit card account hits the predetermined balance, a client device may no longer initiate network transactions with the secured credit card. In some embodiments, once the secured credit card account hits the predetermined balance, the network transaction tracking system 102 or the inter-network facilitation system 104 can automatically pay off a balance of the secured credit account with the predetermined balance money held in the secured credit account.

As mentioned, in one or more embodiments, the secured deposit account is linked to a debit account for funding the secured deposit account. In particular, the network transaction tracking system 102 (or the inter-network facilitation system 104) can facilitate transfers from the debit account to the secured deposit account to fund the secured deposit account. For example, the network transaction tracking system 102 (or the inter-network facilitation system 104) can maintain the predetermined balance of the secured deposit account through automatic transfers from the debit account. To illustrate, upon detecting that the balance of the secured deposit account is below a certain amount, the network transaction tracking system 102 (or the inter-network facilitation system 104) can initiate a transaction from the debit account to the secured deposit account.

As illustrated in FIG. 3, the network transaction tracking system 102 performs an act 304 and receives a request to initiate a network transaction. In particular, the network transaction tracking system 102 receives a request from a client device to initiate a network transaction from a secured deposit account to an additional account (e.g., recipient debit account). Indeed, the network transaction tracking system 102 can facilitate requests from client devices that appear on the client device to be transactions that are not typically supported, such as from a credit account (e.g., the secured credit card account and associated secured deposit account). For example, the network transaction tracking system 102 can receive requests to initiate network transactions from the secured deposit account to an account outside of the inter-network facilitation system 104 (e.g., a peer-to-peer account). Indeed, as previously discussed, the network transaction tracking system 102 facilitates network transactions that conventional transaction management systems cannot facilitate.

As further illustrated in FIG. 3, the network transaction tracking system 102 performs an act 306 and generates movement identifiers. In particular, as previously mentioned, the network transaction tracking system 102 generates a movement identifier for the network transaction. The movement identifier indicates the source accounts, intermediate account(s), and/or destination accounts for the network transaction. For example, the network transaction tracking system 102 can associate (or attach) the movement identifier to each transaction in the secured deposit network transaction chain of the network transaction. Indeed, by utilizing a movement identifier, the network transaction tracking system 102, the inter-network facilitation system 104, and reporting servers can identify a source and destination for funds, satisfying regulatory reporting requirements while also allowing for more flexibility in the types of transactions.

As also illustrated in FIG. 3, the network transaction tracking system 102 generates intermediate movement identifiers for the intermediate transactions of the secured deposit network transaction chain. In particular, the network transaction tracking system 102 generates a first intermediate movement identifier for the first intermediate transaction and a second intermediate movement identifier for the second intermediate transaction. In some cases, the intermediate movement identifiers reference the movement identifier, which allows the network transaction tracking system 102 to further identify which transactions are part of a given network transaction.

As also illustrated in FIG. 3, the network transaction tracking system 102 performs an act 308 and generates a risk prediction for the network transaction. In particular, the network transaction tracking system 102 generates a risk prediction for the network transaction prior to initiating the network transaction. For example, the risk prediction indicates a likelihood of the network transaction failing due to insufficient funds and/or the likelihood that a network transaction is unauthorized or otherwise fraudulent, and the network transaction tracking system 102 determines whether to initiate the network transaction based on the risk prediction. Additional details regarding generating a risk prediction for the network transaction will be provided with respect to FIG. 4 below.

As further illustrated in FIG. 3, the network transaction tracking system 102 performs an act 310 and initiates the network transaction as a secured deposit network transaction chain. In particular, the network transaction tracking system 102 initiates the network transaction by initiating a first intermediate transaction from a secured deposit account to a debit account and then initiating a second intermediate transaction from the debit account to an additional account. In some cases, the network transaction tracking system 102 initiates the first intermediate transaction based on the risk prediction for the network transaction. For example, the network transaction tracking system 102 can determine that the risk prediction satisfies a threshold risk prediction (e.g., indicating the network transaction will likely have funds and/or is not fraudulent) and initiate the network transaction by initiating the first intermediate transaction.

Moreover, as illustrated in FIG. 3, the network transaction tracking system 102 performs an act 312 and provides movement identifiers to reporting servers. In particular, the network transaction tracking system 102 provides the movement identifiers that identify all the transactions in the secured deposit network transaction chain for the network transaction, including the source and destination accounts for the funds. In some cases, the network transaction tracking system 102 can provide the movement identifiers directly to a reporting server (e.g., via network 108). In other cases, the network transaction tracking system 102 provides the movement identifiers to a reporting server by providing the movement identifiers to a money transfer server or a transaction warehousing server that correlates transactions together.

In addition to initiating a network transaction as a secured deposit transaction chain, the network transaction tracking system 102 can also reverse the network transaction as an additional secured deposit transaction chain. In particular, the network transaction tracking system 102 can receive a request to reverse the network transaction (e.g., because the network transaction was fraudulent or otherwise unauthorized). For example, the network transaction tracking system 102 receives, from a client device associated with the network transaction, a request to reverse the network transaction. In some cases, the request to reverse the network transaction can be a digital claim that indicates that the network transaction was unauthorized (or otherwise fraudulent) and the network transaction tracking system 102 can determine whether or not to reverse the network transaction based on the digital claim and/or the information associated with the network transaction.

After determining to reverse the network transaction, the network transaction tracking system 102 can utilize the movement identifiers to identify the transactions in the network transaction. Specifically, the network transaction tracking system 102 utilizes the movement identifier and the intermediate movement identifiers to identify the first intermediate transaction and the second intermediate transaction of the secured deposit network transaction chain. By utilizing the movement identifier and the intermediate movement identifiers to identify transactions in the secured network transaction chain, the network transaction tracking system 102 can identify to which accounts currency or data passed, and the direction of movement for the currency or data.

After utilizing the movement identifiers to identify transactions, the network transaction tracking system 102 can execute an additional network transaction to reverse the network transaction. Specifically, the network transaction tracking system 102 executes an additional network transaction as an additional secured network transaction chain in reverse order of the network transaction. For example, the network transaction tracking system 102 initiates the additional network transaction by initiating a first additional intermediate transaction from the destination account to the intermediate account and a second additional intermediate transaction from the intermediate account to the secured deposit account. To illustrate, the network transaction tracking system 102 initiates the additional network transaction as an additional secured deposit network transaction chain by initiating a first additional intermediate transaction from the additional account to the debit account, then initiating a second additional intermediate transaction from the debit account to the secured deposit account.

In one or more embodiments, the network transaction tracking system 102 generates an additional movement identifier to identify transactions in the network transaction, reversing the network transaction. Specifically, the network transaction tracking system 102 generates an additional movement identifier for the additional network transaction and an additional secured deposit network transaction chain that references the movement identifier. Indeed, by referencing the movement identifier (for the initial network transaction) in the additional movement identifier, the network transaction tracking system 102 is able to identify and track currency or data through several transactions across several accounts.

Moreover, in one or more embodiments, the network transaction tracking system 102 generates an intermediate movement identifier for transactions in the additional secured deposit network transaction chain of the additional network transaction. For example, the network transaction tracking system 102 generates a third intermediate movement identifier for the first additional intermediate transaction (from the destination account to the intermediate account) and a fourth intermediate movement identifier for the second additional intermediate transaction (from the intermediate account to the source account).

As previously mentioned, the network transaction tracking system 102 generates a risk prediction for a network transaction. Specifically, the network transaction tracking system 102 generates a risk prediction by reordering the intermediate transactions of the secured deposit network transaction chain and generating a first risk score for the second intermediate transaction, then generating a second risk score for the first intermediate transaction. FIG. 4 illustrates a schematic diagram of generating a risk profile for a secured network transaction chain in accordance with one or more embodiments.

As illustrated in FIG. 4, the network transaction tracking system 102 performs an act 402 and reorders the intermediate transactions. Specifically, the network transaction tracking system 102 changes the sequence of the intermediate transactions so that the transaction that was last in the sequence of intermediate transactions goes first for generating a risk prediction. For example, the network transaction tracking system 102 will begin the steps of generating a risk prediction with the second intermediate transaction (e.g., from the debit account to the additional account) prior to the first intermediate transaction (e.g., from the secured deposit account to the debit account).

As further illustrated in FIG. 4, the network transaction tracking system 102 performs an act 404 and identifies attributes of the network transaction. In particular, the network transaction tracking system 102 identifies attributes by analyzing various elements or characteristics associated with the network transaction to assess the likelihood of potential risks (e.g., fraud). For example, the network transaction tracking system 102 can identify attributes of the transaction associated with a potential risk that one or more of the transactions in the secured deposit network transaction chain will fail. To illustrate, the network transaction tracking system 102 can identify attributes of the user account associated with the transaction, client device(s) attributes, identity verification attributes, shared-internet-protocol address attributes, customer-service-contact attributes, failed login attributes, transaction frequency attributes (e.g., historical transaction attributes), transaction amount attributes, transaction type attributes, and/or additional account attributes.

As also illustrated in FIG. 4, the network transaction tracking system 102 identifies attributes for each of the intermediate transactions of the secured deposit network transaction chain. In particular, the network transaction tracking system 102 identifies attributes of the second intermediate transaction and attributes of the first intermediate transaction based on attributes unique to each intermediate transaction. For example, the network transaction tracking system 102 identifies attributes based on the various accounts, client devices, user accounts, and locations involved in the intermediate transactions.

As illustrated in FIG. 4, the network transaction tracking system 102 performs an act 406 and generates a risk score for the second intermediate transaction. In particular, the network transaction tracking system 102 provides the identified attributes to a machine-learning model trained to generate one or more risk scores. A machine-learning model can be a computer algorithm or a collection of computer algorithms that automatically improve for a particular task through experience based on the use of data. For example, a machine-learning model can utilize one or more learning techniques to improve accuracy and/or effectiveness (e.g., of the risk prediction and/or risk score). For example, machine-learning models include various types of decision trees, support vector machines, Bayesian networks, or neural networks. In some cases, the machine-learning model is a neural network that can be trained and/or tuned based on inputs to determine classifications or approximate unknown functions. In some cases, one or more algorithms or machine-learning models are incorporated into the network transaction tracking system 102. In other cases, the network transaction tracking system 102 provides the attributes of the network transaction, the second intermediate transaction, and/or the first intermediate transaction to one or more third-party risk analysis server(s) to generate a risk prediction for the network transaction and/or risk scores for the intermediate transactions.

As further illustrated in FIG. 4, the network transaction tracking system 102 performs an act 408 and determines if the first risk score satisfies a first risk threshold. Specifically, the network transaction tracking system 102 determines whether or not to proceed with the network transaction based on whether the first risk score satisfies a risk threshold. For example, if the first risk score for the second intermediate transaction does not satisfy the first risk threshold, the network transaction tracking system 102 can determine to not initiate the network transaction. Indeed, the network transaction tracking system 102 can determine to that if the later portion of the secured deposit network transaction chain is at risk of failure (e.g., the risk of fraud is too high) not to proceed with the network transaction. Conversely, if the first risk score satisfies the first risk threshold, the network transaction tracking system 102 will proceed to generate a risk score for the first intermediate transaction.

As illustrated in FIG. 4, the network transaction tracking system 102 performs an act 410 and generates a second risk score for the first intermediate transaction. Specifically, as just mentioned, the network transaction tracking system 102 generates the second risk score for the first intermediate transaction based on the first risk score satisfying the first risk threshold. For example, the network transaction tracking system 102 utilizes the identified attributes for the first intermediate transaction to generate a risk score for the first intermediate transaction.

As also illustrated in FIG. 4, the network transaction tracking system 102 performs an act 412 and determines if the second risk score satisfies a second risk threshold. Specifically, the network transaction tracking system 102 can determine whether to proceed with initiating the network transaction based on the second risk score (for the first intermediate transaction) satisfying the second risk threshold. For example, if the second risk score does not satisfy the second risk threshold, the network transaction tracking system 102 can determine not to initiate the network transaction.

Further, as illustrated in FIG. 4, the network transaction tracking system 102 performs an act 414 and generates a likelihood that the debit account will have sufficient balance. Specifically, the network transaction tracking system 102 generates the likelihood that the debit account will have funds to satisfy the second intermediate transaction (e.g., enough to cover the amount of the network transaction). For example, if there are issues, outages, or other problems that arise between the first intermediate transaction and the second intermediate transaction, there is a possibility that the deposit from the first intermediate transaction will no longer be in the intermediate account (e.g., spent or otherwise moved out of the account), at which case the second intermediate transaction would fail. In some cases, if the likelihood indicates that the debit account will not have sufficient balance, the network transaction tracking system 102 will determine not to initiate the network transaction.

In one or more embodiments, the network transaction tracking system 102 can adjust the parameters of when to initiate the network transaction. Specifically, the network transaction tracking system 102 can adjust parameters for individual user accounts or for transactions initiated throughout network transaction tracking system 102. For example, the network transaction tracking system 102 can adjust parameters by amending policy writers.

As previously mentioned, the network transaction tracking system 102 utilizes interfaces on a client device to receive and display information related to network transactions. Specifically, the network transaction tracking system 102 receives a request to initiate a network transaction from the user interface and displays information regarding the network transaction in the user interface. FIGS. 5A-5C illustrate example user interfaces of the network transaction tracking system and a schematic diagram of the network transaction determining information to display in the user interface device in accordance with one or more embodiments.

In one or more embodiments, the network transaction tracking system 102 receives a request to initiate a network transaction from a client device. As illustrated in FIG. 5A, the network transaction tracking system 102 displays an option 502 to select a source account from which to initiate the network transaction. Specifically, option 502 includes an option to select a secured credit card account. As previously described, the secured credit card account is associated with the secured deposit account and when the secured credit card option is selected as the source account for the network transaction, the network transaction tracking system 102 will initiate the network transaction by initiating a transaction from the secured deposit account. As shown in FIG. 5A, the network transaction tracking system 102 also displays an option 504 to receive a selection or input of an amount for the network transaction.

As also illustrated in FIG. 5A, the network transaction tracking system 102 displays options for destination accounts for the network transaction. In particular, the network transaction tracking system 102 displays an option 506 to initiate a network transaction to another account associated with the user account and an option 508 to initiate a network transaction to an account associated with another user account or an account outside the inter-network facilitation system 104.

As previously explained, the network transaction tracking system 102 intelligently displays information to a client device that relates to the network transaction based on the received input from the client device to initiate the network transaction. FIG. 5B illustrates an example schematic diagram of the network transaction tracking system 102 determining information to display in a user interface on a client device.

As shown, the network transaction tracking system 102 performs an act 510 and receives a request to initiate a network transaction. For example, the network transaction tracking system 102 receives a request to initiate a network transaction, as depicted in FIG. 5A, where the client device indicates a source account and a destination account for the network transaction. Then, as illustrated, the network transaction tracking system 102 can perform an act 512 and initiate the network transaction as a secured deposit network transaction chain. Additional detail regarding initiating the network transaction as a secured deposit network transaction chain is provided with respect to FIG. 3 above.

As illustrated, the network transaction tracking system 102 performs an act 514 and identifies intermediate transactions. In particular, the network transaction tracking system 102 identifies that the transactions from the source account to the intermediate account and the intermediate account to the destination account are intermediate transactions. For example, the intermediate transactions are used by the network transaction tracking system 102 (e.g., to satisfy regulatory reporting requirements) but may elicit confusion if displayed in the user interface on the client device. To illustrate, if the network transaction tracking system 102 receives a request a network transaction that indicates the secured credit account as the source account and an additional account as the destination account, if the network transaction tracking system 102 displayed a transaction to a debit account, that may elicit confusion. As also illustrated, the network transaction tracking system 102 can then perform an act 516 and display the network transaction by displaying a network transaction from the source account to the destination account.

FIG. 5C illustrates an example of the network transaction tracking system 102 displaying the network transaction in a user interface on a client device. In particular, as just described, the network transaction tracking system 102 displays the network transaction as a transaction from the secured deposit account to an additional account in window 518 of the user interface. For example, as illustrated, the network transaction tracking system 102 shows the network transaction as a transaction in the list of transactions of the secured deposit account. As also shown in window 520 of the user interface, the network transaction tracking system 102 does not display a transaction to the debit account in the list of transactions for the debit account.

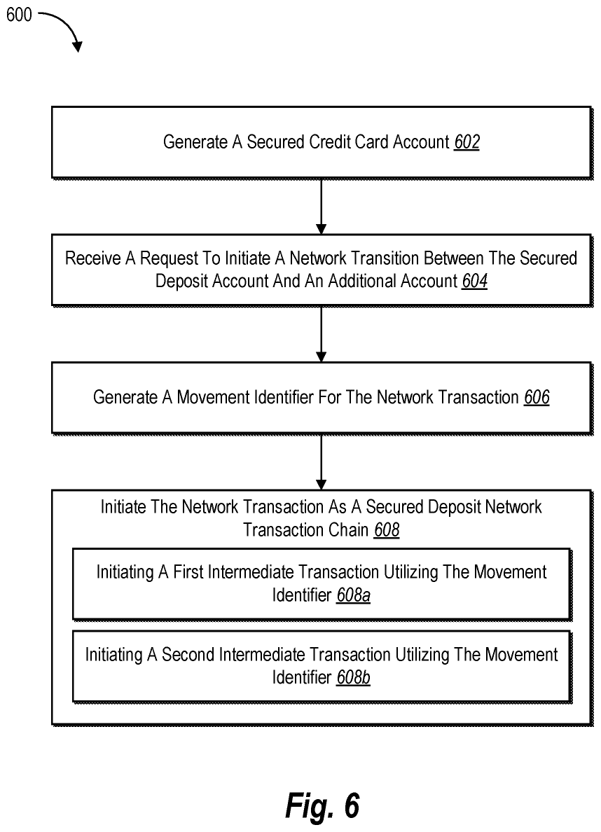

FIG. 6, the corresponding text, and the examples provide a number of different methods, systems, devices, and non-transitory computer-readable media of the network transaction tracking system 102. In addition to the foregoing, one or more embodiments can also be described in terms of flowcharts comprising acts for accomplishing a particular result, as shown in FIG. 6. FIG. 6 may be performed with more or fewer acts. Further, the acts may be performed in differing orders. Additionally, the acts described herein may be repeated or performed in parallel with one another or parallel with different instances of the same or similar acts.

As mentioned, FIG. 6 illustrates a flowchart of a series of acts 600 for tracking a net in accordance with one or more embodiments. While FIG. 6 illustrates acts according to one embodiment, alternative embodiments may omit, add to, reorder, and/or modify any of the acts shown in FIG. 6. The acts of FIG. 6 can be performed as part of a method. Alternatively, a non-transitory computer-readable medium can comprise instructions that, when executed by one or more processors, cause a computing device to perform the acts of FIG. 6. In some embodiments, a system can perform the acts of FIG. 6.

As shown in FIG. 6, the series of acts 600 includes an act 602 of generating a secured credit card account, an act 604 of receiving a request to initiate a network transaction between the secured deposit account and an additional account, an act 606 of generating a movement identifier for the network transaction, and an act 608 of initiating the network transaction as a secured deposit network transaction chain, which includes an act 608a of initiating a first intermediate transaction utilizing the movement identifier and an act 608b of initiating a second intermediate transaction utilizing the movement identifier.

In particular, the act 602 can include generating a secured credit card account corresponding to a secured deposit account and linked to a debit account for funding the secured deposit account, the act 604 can include receiving a request to initiate a network transaction between the secured deposit account and an additional account, and the act 606 can include generating a movement identifier for the network transaction, and the act 608 can include initiating the network transaction as a secured deposit network transaction chain by initiating a first intermediate transaction from the secured deposit account to the debit account utilizing the movement identifier, and initiating a second intermediate transaction from the debit account to the additional account utilizing the movement identifier

For example, in one or more embodiments, the act 608 includes initiating the network transaction as a secured deposit network transaction by generating a first intermediate movement identifier for the first intermediate transaction that refers to the movement identifier, generating a second intermediate movement identifier for the second intermediate transaction that refers to the movement identifier, and providing the movement identifier, the first intermediate movement identifier, and the second intermediate movement identifier to a reporting server.

In addition, in one or more embodiments, the series of acts 600 includes providing, for display via a user interface of a client device associated with the secured deposit account and the debit account, an indication of the network transaction by displaying a transaction from the secured deposit account and the additional account. Further, in one or more embodiments, the series of acts 600 includes wherein displaying the transaction from the secured deposit account and the additional account comprises displaying the transaction without displaying the first intermediate transaction and the second intermediate transaction in the user interface of the client device.

Furthermore, in one or more embodiments, the series of acts 600 includes generating, utilizing a third-party risk analysis model, a risk prediction for the network transaction by reordering the first intermediate transaction and the second intermediate transaction and initiating the network transaction as the secured deposit network transaction chain according to the risk prediction. In addition, in one or more embodiments, the series of acts 600 includes generating the risk prediction by reordering the first intermediate transaction and the second intermediate transaction by generating a first risk score for the second intermediate transaction and upon generating the first risk score, generating a second risk score for the first intermediate transaction.

Moreover, in one or more embodiments, the series of acts 600 includes receiving a request to reverse the network transaction and, in response to receiving the request to reverse the network transaction, utilizing the movement identifier to identify the first intermediate transaction and the second intermediate transaction.

Also, in one or more embodiments, the series of acts 600 includes executing an additional network transaction to reverse the network transaction by generating an additional movement identifier for the additional network transaction and initiating the additional network transaction as an additional secured deposit network transaction chain utilizing the additional movement identifier and the movement identifier. Further, in one or more embodiments, the series of acts 600 includes initiating the additional network transaction as an additional secured deposit network transaction chain by initiating a first additional intermediate transaction from the additional account to the debit account utilizing the additional movement identifier and a third intermediate movement identifier and initiating a second additional intermediate transaction from the debit account to the secured deposit account utilizing the additional movement identifier a fourth intermediate movement identifier.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 7 illustrates a block diagram of an example computing device 700 that may be configured to perform one or more of the processes described above. One will appreciate that one or more computing devices, such as the computing device 700 may represent the computing devices described above (e.g., server(s) 106, third-party risk analysis server(s) 116, and client device(s) 110). In one or more embodiments, the computing device 700 may be a mobile device (e.g., a mobile telephone, a smartphone, a PDA, a tablet, a laptop, a camera, a tracker, a watch, a wearable device, etc.). In some embodiments, the computing device 700 may be a non-mobile device (e.g., a desktop computer or another type of client device). Further, the computing device 700 may be a server device that includes cloud-based processing and storage capabilities.

As shown in FIG. 7, the computing device 700 can include one or more processor(s) 702, memory 704, a storage device 706, input/output interfaces 708 (or “I/O interfaces 708”), and a communication interface 710, which may be communicatively coupled by way of a communication infrastructure (e.g., bus 712). While the computing device 700 is shown in FIG. 7, the components illustrated in FIG. 7 are not intended to be limiting. Additional or alternative components may be used in other embodiments. Furthermore, in certain embodiments, the computing device 700 includes fewer components than those shown in FIG. 7. Components of the computing device 700 shown in FIG. 7 will now be described in additional detail.

In particular embodiments, the processor(s) 702 includes hardware for executing instructions, such as those making up a computer program. As an example, and not by way of limitation, to execute instructions, the processor(s) 702 may retrieve (or fetch) the instructions from an internal register, an internal cache, memory 704, or a storage device 706 and decode and execute them.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 704 may be internal or distributed memory.

The computing device 700 includes a storage device 706 includes storage for storing data or instructions. As an example, and not by way of limitation, the storage device 706 can include a non-transitory storage medium described above. The storage device 706 may include a hard disk drive (HDD), flash memory, a Universal Serial Bus (USB) drive or a combination these or other storage devices.

As shown, the computing device 700 includes one or more I/O interfaces 708, which are provided to allow a user to provide input to (such as user strokes), receive output from, and otherwise transfer data to and from the computing device 700. These I/O interfaces 708 may include a mouse, keypad or a keyboard, a touch screen, camera, optical scanner, network interface, modem, other known I/O devices or a combination of such I/O interfaces 708. The touch screen may be activated with a stylus or a finger.

The I/O interfaces 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 708 are configured to provide graphical data to a display for presentation to a user. The graphical data may be representative of one or more graphical user interfaces and/or any other graphical content as may serve a particular implementation.

The computing device 700 can further include a communication interface 710. The communication interface 710 can include hardware, software, or both. The communication interface 710 provides one or more interfaces for communication (such as, for example, packet-based communication) between the computing device and one or more other computing devices or one or more networks. As an example, and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI. The computing device 700 can further include a bus 712. The bus 712 can include hardware, software, or both that connects components of computing device 700 to each other.

FIG. 8 illustrates an example network environment 800 of the inter-network facilitation system 104. The network environment 800 includes a client device 806 (e.g., client device(s) 110), an inter-network facilitation system 104, and a third-party system 808 connected to each other by a network 804. Although FIG. 8 illustrates a particular arrangement of the client device 806, the inter-network facilitation system 104, the third-party system 808, and the network 804, this disclosure contemplates any suitable arrangement of client device 806, the inter-network facilitation system 104, the third-party system 808, and the network 804. As an example, and not by way of limitation, two or more of client device 806, the inter-network facilitation system 104, and the third-party system 808 communicate directly, bypassing network 804. As another example, two or more of client device 806, the inter-network facilitation system 104, and the third-party system 808 may be physically or logically co-located with each other in whole or in part.

Moreover, although FIG. 8 illustrates a particular number of client devices 806, inter-network facilitation system 104, third-party systems 808, and networks 804, this disclosure contemplates any suitable number of client devices 806, FIG. 8, third-party systems 808, and networks 804. As an example, and not by way of limitation, network environment 800 may include multiple client devices 806, inter-network facilitation system 104, third-party systems 808, and/or networks 804.

This disclosure contemplates any suitable network 804. As an example, and not by way of limitation, one or more portions of network 804 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 804 may include one or more networks 804.

Links may connect client device 806, inter-network facilitation system 104 (e.g., which hosts the network transaction tracking system 102), and third-party system 808 to network 804 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 800. One or more first links may differ in one or more respects from one or more second links.

In particular embodiments, the client device 806 may be an electronic device including hardware, software, or embedded logic components or a combination of two or more such components and capable of carrying out the appropriate functionalities implemented or supported by client device 806. As an example, and not by way of limitation, a client device 806 may include any of the computing devices discussed above in relation to FIG. 7. A client device 806 may enable a network user at the client device 806 to access network 804. A client device 806 may enable its user to communicate with other users at other client devices 806.

In particular embodiments, the client device 806 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device 806 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 806 one or more Hyper Text Markup Language (“HTML”) files responsive to the HTTP request. The client device 806 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 804) to link the third-party-system 808. For example, the inter-network facilitation system 104 may receive authentication credentials from a user to link a third-party system 808 such as an online bank account, credit account, debit account, or other financial account to a user account within the inter-network facilitation system 104. The inter-network facilitation system 104 can subsequently communicate with the third-party system 808 to detect or identify balances, transactions, withdrawal, transfers, deposits, credits, debits, or other transaction types associated with the third-party system 808. The inter-network facilitation system 104 can further provide the aforementioned or other financial information associated with the third-party system 808 for display via the client device 806. In some cases, the inter-network facilitation system 104 links more than one third-party system 808, receiving account information for accounts associated with each respective third-party system 808 and performing operations or transactions between the different systems via authorized network connections.

In particular embodiments, the inter-network facilitation system 104 may interface between an online banking system and a credit processing system via the network 804. For example, the inter-network facilitation system 104 can provide access to a bank account of a third-party system 808 and linked to a user account within the inter-network facilitation system 104. Indeed, the inter-network facilitation system 104 can facilitate access to, and transactions to and from, the bank account of the third-party system 808 via a client application of the inter-network facilitation system 104 on the client device 806. The inter-network facilitation system 104 can also communicate with a credit processing system, an ATM system, and/or other financial systems (e.g., via the network 804) to authorize and process credit charges to a credit account, perform ATM transactions, perform transfers (or other transactions) across accounts of different third-party systems 808, and to present corresponding information via the client device 806.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 808), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 800 either directly or via network 804. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 806, or an inter-network facilitation system 104 to manage, retrieve, modify, add, or delete, the information stored in a data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 804.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 806. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 806. Information may be pushed to a client device 806 as notifications, or information may be pulled from client device 806 responsive to a request received from client device 806. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 806 associated with users.

In addition, the third-party system 808 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 804. A third-party system 808 can communicate with the inter-network facilitation system 104 to provide financial information pertaining to balances, transactions, and other information, whereupon the inter-network facilitation system 104 can provide corresponding information for display via the client device 806. In particular embodiments, a third-party system 808 communicates with the inter-network facilitation system 104 to update account balances, transaction histories, credit usage, and other internal information of the inter-network facilitation system 104 and/or the third-party system 808 based on user interaction with the inter-network facilitation system 104 (e.g., via the client device 806). Indeed, the inter-network facilitation system 104 can synchronize information across one or more third-party systems 808 to reflect accurate account information (e.g., balances, transactions, etc.) across one or more networked systems, including instances where a transaction (e.g., a transfer) from one third-party system 808 affects another third-party system 808.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A system comprising:
at least one processor; and
at least one non-transitory computer-readable storage medium storing instructions that, when executed by the at least one processor, cause the system to:
generate a secured credit card account corresponding to a secured deposit account and linked to a debit account for funding the secured deposit account;
receive a request to initiate a network transaction between the secured deposit account and an additional account;
generate a movement identifier for the network transaction; and
initiate the network transaction as a secured deposit network transaction chain by:
initiating a first intermediate transaction from the secured deposit account to the debit account utilizing the movement identifier; and
initiating a second intermediate transaction from the debit account to the additional account utilizing the movement identifier.

2. The system of claim 1, further comprising instructions that, when executed by the at least one processor, cause the system to initiate the network transaction as a secured deposit transaction chain by:
generating a first intermediate movement identifier for the first intermediate transaction that refers to the movement identifier;
generating a second intermediate movement identifier for the second intermediate transaction that refers to the movement identifier; and
providing the movement identifier, the first intermediate movement identifier, and the second intermediate movement identifier to a reporting server.

3. The system of claim 1, further comprising instructions that, when executed by the at least one processor, cause the system to provide, for display via a user interface of a client device associated with the secured deposit account and the debit account, an indication of the network transaction by displaying a transaction from the secured deposit account and the additional account.

4. The system of claim 3, wherein displaying the transaction from the secured deposit account and the additional account comprises displaying the transaction without displaying the first intermediate transaction and the second intermediate transaction in the user interface of the client device.

5. The system of claim 1, further comprising instructions that, when executed by the at least one processor, cause the system to:
generate, utilizing a third-party risk analysis model, a risk prediction for the network transaction by reordering the first intermediate transaction and the second intermediate transaction; and
initiating the network transaction as the secured deposit network transaction chain according to the risk prediction.

6. The system of claim 5, further comprising instructions that, when executed by the at least one processor, cause the system to generate the risk prediction by reordering the first intermediate transaction and the second intermediate transaction by:
generating a first risk score for the second intermediate transaction; and
upon generating the first risk score, generating a second risk score for the first intermediate transaction.

7. The system of claim 1, further comprising instructions that, when executed by the at least one processor, cause the system to:
receive a request to reverse the network transaction; and
in response to receiving the request to reverse the network transaction, utilize the movement identifier to identify the first intermediate transaction and the second intermediate transaction.

8. The system of claim 7, further comprising instructions that, when executed by the at least one processor, cause the system to execute an additional network transaction to reverse the network transaction by:
generating an additional movement identifier for the additional network transaction; and
initiating the additional network transaction as an additional secured deposit network transaction chain utilizing the additional movement identifier and the movement identifier.

9. The system of claim 8, further comprising instructions that, when executed by the at least one processor, cause the system to initiate the additional network transaction as an additional secured deposit network transaction chain by:
initiating a first additional intermediate transaction from the additional account to the debit account utilizing the additional movement identifier and a third intermediate movement identifier; and
initiating a second additional intermediate transaction from the debit account to the secured deposit account utilizing the additional movement identifier and a fourth intermediate movement identifier.

10. A computer-implemented method comprising:
generating a secured credit card account corresponding to a secured deposit account and linked to a debit account for funding the secured deposit account;
receiving a request to initiate a network transaction between the secured deposit account and an additional account;
generating a movement identifier for the network transaction; and
initiating the network transaction as a secured deposit network transaction chain by:
initiating a first intermediate transaction from the secured deposit account to the debit account utilizing the movement identifier; and
initiating a second intermediate transaction from the debit account to the additional account utilizing the movement identifier.

11. The computer-implemented method of claim 10, further comprising initiating the network transaction as a secured deposit transaction chain by:
generating a first intermediate movement identifier for the first intermediate transaction that refers to the movement identifier;
generating a second intermediate movement identifier for the second intermediate transaction that refers to the movement identifier; and
providing the movement identifier, the first intermediate movement identifier, and the second intermediate movement identifier to a reporting server.

12. The computer-implemented method of claim 10, further comprising providing, for display via a user interface of a client device associated with the secured deposit account and the debit account, an indication of the network transaction by displaying a transaction from the secured deposit account and the additional account and without displaying the first intermediate transaction and the second intermediate transaction in the user interface of the client device.

13. The computer-implemented method of claim 10, further comprising:
generating, utilizing a third-party risk analysis model, a risk prediction for the network transaction by reordering the first intermediate transaction and the second intermediate transaction by:
generating a first risk score for the second intermediate transaction; and
upon generating the first risk score, generating a second risk score for the first intermediate transaction; and
initiating the network transaction as the secured deposit network transaction chain according to the risk prediction.

14. The computer-implemented method of claim 10, further comprising:
executing an additional network transaction to reverse the network transaction by:
generating an additional movement identifier for the additional network transaction; and
initiate the additional network transaction as an additional secured deposit network transaction chain utilizing the additional movement identifier and the movement identifier.

15. The computer-implemented method of claim 14, further comprising initiating the additional network transaction as an additional secured deposit network transaction chain:
initiating a first additional intermediate transaction from the additional account to the debit account utilizing the additional movement identifier and a third intermediate movement identifier; and
initiating a second additional intermediate transaction from the debit account to the secured deposit account utilizing the additional movement identifier a fourth intermediate movement identifier.

16. A non-transitory computer-readable medium storing instructions that, when executed by at least one processor, cause a computer system to:
generate a secured credit card account corresponding to a secured deposit account and linked to a debit account for funding the secured deposit account;
receive a request to initiate a network transaction between the secured deposit account and an additional account;
generate a movement identifier for the network transaction; and
initiate the network transaction as a secured deposit network transaction chain by:
initiating a first intermediate transaction from the secured deposit account to the debit account utilizing the movement identifier; and
initiating a second intermediate transaction from the debit account to the additional account utilizing the movement identifier.

17. The non-transitory computer-readable medium of claim 16, further comprising instructions that, when executed by the at least one processor, cause the computer system to initiate the network transaction as a secured deposit transaction chain by:
generating a first intermediate movement identifier for the first intermediate transaction that refers to the movement identifier;
generating a second intermediate movement identifier for the second intermediate transaction that refers to the movement identifier; and
providing the movement identifier, the first intermediate movement identifier, and the second intermediate movement identifier to a reporting server.

18. The non-transitory computer-readable medium of claim 16, further comprising instructions that, when executed by the at least one processor, cause the computer system to provide, for display via a user interface of a client device associated with the secured deposit account and the debit account, an indication of the network transaction by displaying a transaction from the secured deposit account and the additional account and without displaying the first intermediate transaction and the second intermediate transaction in the user interface of the client device.

19. The non-transitory computer-readable medium of claim 16, further comprising instructions that, when executed by the at least one processor, cause the computer system to execute an additional network transaction to reverse the network transaction by:
generating an additional movement identifier for the additional network transaction; and
initiating the additional network transaction as an additional secured deposit network transaction chain utilizing the additional movement identifier and the movement identifier by:
initiating a first additional intermediate transaction from the additional account to the debit account utilizing the additional movement identifier and a third intermediate movement identifier; and
initiating a second additional intermediate transaction from the debit account to the secured deposit account utilizing the additional movement identifier a fourth intermediate movement identifier.

20. The non-transitory computer-readable medium of claim 16, further comprising instructions that, when executed by the at least one processor, cause the computer system to:
generate, utilizing a third-party risk analysis model, a risk prediction for the network transaction by reordering the first intermediate transaction and the second intermediate transaction by:
generating a first risk score for the second intermediate transaction; and
upon generating the first risk score, generating a second risk score for the first intermediate transaction; and
initiate the network transaction as the secured deposit network transaction chain according to the risk prediction.
